(19) United States
(12) Patent Application Publication
(10) Pub. No.: US 2008/0187637 A1
(43) Pub. Date: Aug. 7, 2008

(54) Method and device for decorating or depositing components on a horizontal section of flat bakeware

(75) Inventor: Udo Spiegel, Bielefeld (DE)

Correspondence Address: VENABLE LLP, P.O. BOX 34385, WASHINGTON, DC, 20043-9998, US

(73) Assignee: Dr. August Oetker Nahrungsmittel KG, Bielefeld (DE)

(21) Appl. No.: 12/010,887

(22) Filed: Jan. 30, 2008

(30) Foreign Application Priority Data
Jan. 31, 2007 (DE) 10 2007 005 735.2

(51) Int. Cl. A23P 1/00; A23G 3/28

(52) U.S. Cl. 426/383; 99/485

(57) ABSTRACT

A method for depositing a topping on a horizontal section of a flat baked item along a production line improves the visual presentation of baked items. The device for decorating or depositing a topping onto the horizontal section is provided with an endless conveyor for transporting the baked item along the production line, at least one station for depositing at least one distribution component, and at least one following station for depositing at least one piece component, wherein the at least one station for depositing the at least one distribution component is provided with a guiding device that creates at least one non-covered area on the horizontal section during the deposit of the distribution component, and wherein the at least one station for depositing the at least one piece component includes a dispensing device for the targeted dispensing of the piece component onto the at least one non-covered area.

### CROSS-REFERENCE TO RELATED APPLICATION

This application claims the priority of German Patent Application DE 10 2007 005 735.2, filed on Jan. 31, 2007, the subject matter of which is incorporated herein by reference.

The invention relates to a continuous method for decorating a horizontal section of a flat baked item or placing toppings thereon along a production line for producing baked goods, said method comprising the following steps: a) providing the flat baked item at one station along the production line; b) depositing at least one distribution component onto the horizontal section at a following station along the production line; and c) placing at least one piece of a topping component onto the horizontal section at a following station along the production line.

### PRIOR ART

A device for placing a plurality of different toppings on a single pizza crust is described in the German Patent Application 10 2005 034 510 B3. The device comprises storage containers in a matrix-type arrangement for the topping components, as well as a moving carrier for a pizza crust, which can be positioned underneath a respective storage container. The storage containers are opened successively for the targeted depositing of the topping component onto the crust arranged on the carrier below.

The European Patent 0947 137 B1 discloses a device for distributing cheese onto a pizza crust. A scale is used for predetermining an amount of grated cheese, which is then moved into a first truncated-cone shaped guide chute, which has an opening with a smaller cross section that points downward. A portion of the cheese hits a cone with the tip pointing upward, which is arranged inside this guide chute, thereby causing an even distribution of the cheese. The truncated-cone shaped guide chute guides the cheese onto a second cone, which is arranged in axial direction of the first cone and also has an upward pointing tip. As a result, the cheese is again distributed more evenly. The cheese subsequently falls through a cylindrical guide chute and onto the pizza crust. The distribution of the cheese on the pizza crust can be influenced by adjusting the absolute height position of the cones, as well as the position of the cones relative to each other, for example to arrange more cheese along the circular edge of the pizza crust. At the following stations, additional ingredients such as vegetables or pieces of fruit are then deposited onto the pizza crust covered in this way with grated cheese.

One disadvantage of the known device and the associated method for placing toppings onto the pizza crust is that the pizza crust gives the appearance of being covered unevenly and randomly.

A further disadvantage relates to frozen pizza produced in this way. Sliced ingredients such as slices of salami or mozzarella, which are placed onto the grated cheese, can move around freely inside the packaging for the frozen pizza. If an end user opens the packaging for the frozen pizza, the freely moving ingredients often drop out of the package and onto the floor, which is not desirable.

The topping component can furthermore dry out if it is placed directly onto the distribution component. On the other hand, if the topping component is placed underneath the distribution component, it is not visible or not completely visible to the end user.

### OBJECT OF THE INVENTION

It is therefore the object of the present invention to provide a device and a method which improve the visual presentation of baked items of this type and which avoid the loose arrangement of topping components.

### GENERAL DESCRIPTION OF THE INVENTION

This object is solved according to the invention with a continuous method for decorating a horizontal section of a flat baked item or depositing toppings thereon, as component of a production line for producing the finished baked item with toppings, said method involving the steps of

a) placing the flat baked item onto a continuously circulating conveyor, e.g. at a station along a production line;
b) depositing at least one distribution component onto the horizontal section at a following station along the production line, as seen in conveying direction of the continuously circulating conveyor; and
c) depositing at least one piece of a topping component onto the horizontal section at a following station along the production, as seen in conveying direction, wherein these steps involve:
d) forming at least one area on the horizontal section, which is not covered by a distribution component during the step b), and
e) arranging at least one piece of a topping component on the at least one area that is left uncovered during step d).

The baked item advantageously is a pizza crust, a cake, half of a baguette, half of a roll, or the dough crust for a regional specialty called “Flammkuchen.”

The horizontal section advantageously covers the complete flat top surface of the baked item.

The distribution component preferably consists of grated cheese, frozen hamburger meat, fruit or vegetables, sugar or powdered sugar while the topping component consists of salami slices, pineapple slices, mozzarella slices, slices of meat or fish, pieces of chocolate or marzipan.

The distribution component is advantageously deposited continuously, for example by using a cascading technique, while the topping component is placed onto the at least one non-covered area either manually or with the aid of a dispensing device. The technique for depositing the distribution component by continuously or intermittently discharging the distribution component from a distributing device over a product conveyor region that is arranged below the distributing device is referred to as cascading technique. The component can be discharged at the end of the distributing device, for example a conveyor belt, meaning at the point where the belt is guided around a deflection roller and forms a discharge edge.

According to one modification, the non-covered areas can be formed by using covering elements or a template, arranged in the dropping path for the distribution component, for example between the distributing device and a baked item such as a dough piece arranged on the product conveyor. The covering elements or the template are preferably arranged such that their cross section is perpendicular and/or vertical to the continuous conveyor, meaning substantially tapered toward the top as seen in dropping direction of the distribution component, so as to minimize the deposit of the distribution component thereon.

According to a different modification, the distribution component is deposited with the aid of a controlled feeding device, e.g. a feed tube or a distribution device such as a powdered-sugar sprinkler, onto selected areas of the horizontal section, which are not areas to be kept free of the covering.

A piece of the topping component is preferably deposited in a non-covered area, wherein the shape and size of the non-covered area advantageously corresponds to the shape and size of the topping component to be deposited thereon.

Alternatively, several pieces of the topping component can also be arranged in a non-covered area.

According to a different modified embodiment, the same topping component is arranged in each of the non-covered areas.

Alternatively, a different topping component can also be placed onto each of the at least two non-covered areas.

A liquid component can be applied to the horizontal section prior to the step b).

The liquid component advantageously consists of a sauce and especially a tomato sauce or a salad oil, preferably mixed with spices, or it can be a chocolate or vanilla sauce, or whipped cream that is sprayed on.

The object is furthermore solved according to the invention with a continuously operating device for realizing the method according to the invention, wherein this device can be part of a production line for decorating or depositing toppings on a horizontal section of a flat baked item and can comprise a continuously operating endless conveyor for transporting the baked items along the production line, with at least one station for depositing a distribution component and at least one station, following in conveying direction of the endless conveyor, for depositing at least one topping component. The at least one station for depositing the at least one distribution component is provided with a guiding device for forming the at least one non-covered area on the horizontal section of the baked item, which is kept free of the distributed component. The guiding device is preferably designed such that at least one non-covered area is formed on the horizontal section of the baked item during the depositing of the distribution component. It is furthermore preferable if the guiding device is provided inside a guide chute with at least one covering element or a template with a covering surface, for which the cross sections correspond to the segments on the baked item on which the areas not covered by the distribution component are formed.

The at least one station for depositing the at least one topping component preferably comprises a device for the targeted dispensing of the topping component onto the at least one non-covered area. The guiding device can advantageously be moved over a segment of the endless conveyor, moving at a distance and parallel thereto and preferably at the same speed. The guiding device is provided with an exit opening, for which the maximum cross section is equal to the outer circumference of the baked item, so that the supplied distribution component can be deposited purposely onto the horizontal segment of the surface area, within the outer circumference of the baked item.

The guiding device advantageously is a controlled feeding device, which deposits the distribution component onto specifically selected areas of the horizontal section, thereby forming the at least one non-covered area.

The guiding device preferably comprises a guide chute, with a maximum inside cross-sectional circumference that is equal to the outer circumference of the surface of the baked item onto which the distribution component is deposited. The guide chute can advantageously be positioned in such a way that the spanned cross section, preferably its lower exit opening, is arranged substantially parallel to the top surface of the endless conveyor.

The device and/or station for depositing a topping component can thus be arranged in front of the guiding device, as seen in conveying direction of the endless conveyor, since the guiding device according to the invention with therein arranged covering elements or a template can form areas not covered by the distribution component within the distribution component on the horizontal section of the baked item. The positioning of the piece component on the later-formed areas on the baked item that are not covered by the distribution component does not influence the later deposit of the distribution component with the aid of the guiding device or the screening of non-covered areas against the distribution component by using covering elements or a template inside the guiding device.

The guiding device is advantageously provided with a positioning device, which allows the guiding device to traverse at a distance from and parallel to the surface of the endless conveyor. With the aid of the positioning device, the guiding device can preferably traverse in alternating directions, e.g. with a first movement in the direction and with the same speed as the endless conveyor and with a second movement in the opposite direction as the endless conveyor and back to the starting position for the first movement, preferably at a faster speed than during the first movement. For the first movement, the guiding device can thus be positioned especially preferred in a position vertically above the baked item on the endless conveyor, and can traverse parallel, at the same speed and with the precise positioning of the baked item on the endless conveyor, so that the distribution component falling through the guide chute is deposited precisely within the outer circumference of the area of the baked item. The second movement, which can be realized alternating with the first movement, is designed to move the guiding device back to the starting position for the first movement. The positioning device can therefore be configured such that for the second movement the guiding device moves at a faster speed than for the first movement.

With respect to the product-conveying direction of the endless conveyor, the starting position for the first movement is in front of its end position, e.g. closer to the deflection roller at the start of the endless conveyor, while the end position for the first movement is arranged downstream in product-conveying direction, e.g. closer to the deflection roller at the end.

In the starting position for the first movement, the positioning device is preferably configured such that it moves the guiding device from a position where it is at a greater distance to the endless conveyor to a position closer to the endless conveyor and to allow the first movement to run its course while positioned at a short distance to the endless conveyor. In the end position of the first movement, the guiding device must then be moved back again to be at a greater distance to the endless conveyor. The positioning device is preferably configured such that the second movement can be realized at a greater distance to the endless conveyor. For this embodiment, several guiding devices can be provided, which are arranged at a distance to and parallel to the endless conveyor and which can respectively be moved one after another and aligned with successively conveyed baked items by using a positioning device assigned thereto.

To position the guiding device at a distance and vertically above the baked items on the endless conveyor, the positioning device preferably comprises a detection unit for detecting the position and movement of the baked items on the endless conveyor. The positioning device can thus be controlled to move synchronized with the movement of the baked items on the endless conveyor, in dependence on the signals from the detection unit. The detection unit can be a light scanner, which optically detects the position of baked items on the conveying device. It is furthermore preferable if a control unit is used to control a device for supplying a distribution component to a dispensing device, the endless conveyor or the product conveyor for conveying the baked items, as well as the positioning device for controlling the guiding device in dependence on the signals from a detection unit, which indicate the position of the baked items on the product conveyor. As an alternative to the detection unit, the positioning unit can also be configured to receive a signal from the station that positions the baked items such as dough pieces on the endless conveyor. The connection between the positioning device and the detection unit, e.g. via a control unit, for receiving its signals, or for receiving the signals from the station for depositing the baked items on the endless conveyor, allows synchronizing the translatory method used by the positioning device for the first movement with the movement of the baked items. The positioning device is preferably configured such that the speed for the first movement is synchronized with the speed of the endless conveyor, for example by configuring the positioning device to receive a signal for the speed of the endless conveyor and, in dependence thereof, control the first movement. Alternatively, it is possible to provide a control unit which controls the first movement in dependence on a signal for the speed of the endless conveyor.

The endless conveyor is preferably a continuously circulating conveying belt, the top surface of which is advantageously arranged horizontal in order to accommodate the baked items.

The at least one station for depositing the at least one distribution component with the aid of a distributing device is preferably provided with a control unit for depositing the distribution component with a cascading technique. A distributing device of this type can be a continuously circulating conveying belt where the distribution component is discharged at the one deflection roller under the effect of gravity. The distributing device is preferably adjusted such that the component is conveyed during the first movement of the guiding device into the guiding device, e.g. into an intake opening that is connected to the guiding device. The distributing device is thus adapted and configured to move the distribution component into an intake opening of the guiding device to ensure the targeted deposit on the baked item during the first traversing movement of the guiding device. This adjustment of the distributing device to the movement of the guiding device allows a targeted deposit of the distribution component on the baked item, preferably while leaving at least one area on the baked item uncovered, thereby significantly reducing or totally eliminating the danger of any distribution component from falling onto the endless conveyor outside of the baked item.

### PRECISE DESCRIPTION OF THE INVENTION

The invention is explained in the following with the aid of an exemplary embodiment and reference to the drawing, wherein:

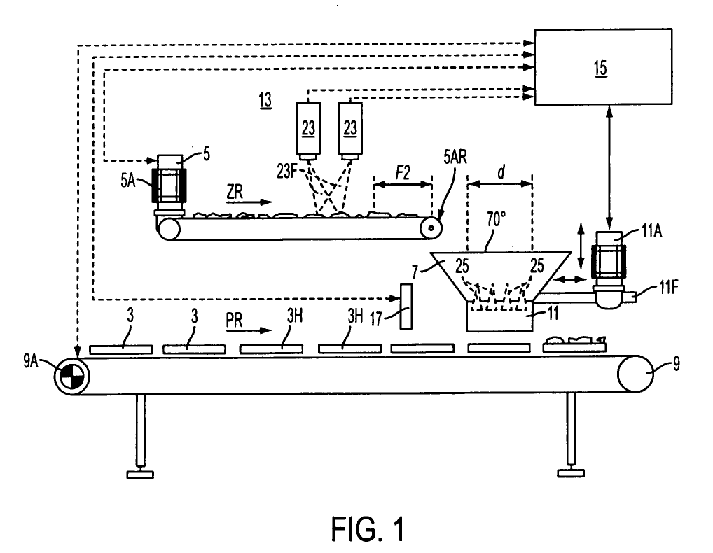

FIG. 1 shows a schematic representation of a device according to the invention for depositing a distribution component on a horizontal section of a pizza crust, which represents the baked item; and

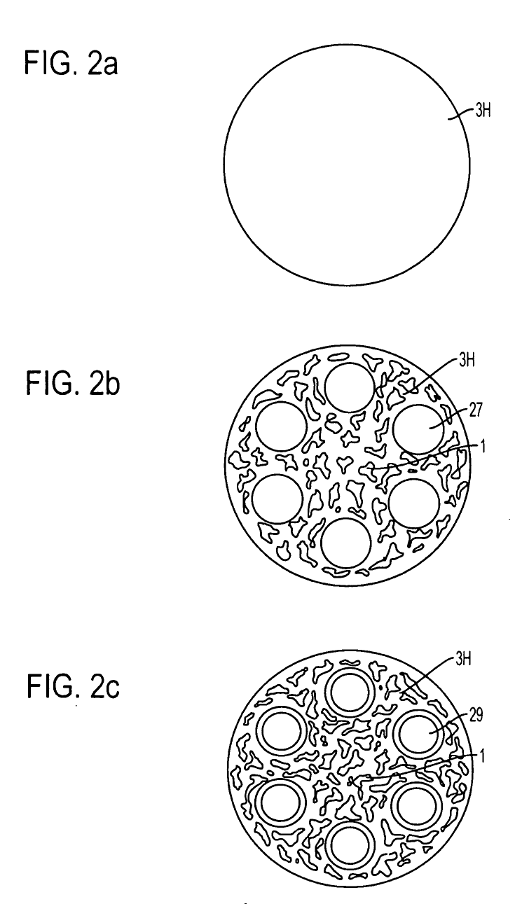

FIGS. 2a, 2b, and 2c show a schematic view from above of a pizza crust at various stages of the production.

A device according to the invention for depositing a distribution component 1 onto a horizontal section 3H of a flat baked item 3 is shown in FIG. 1, wherein this device is a station along a production line for producing frozen pizzas. The flat baked item 3 is a circular pizza crust while the horizontal section 3H essentially represents the complete flat top surface of the pizza crust.

The device shown in FIG. 1 comprises a product conveyor 9 in the form of a conveying belt on which flat baked items 3 are conveyed continuously in a product-conveying direction PR.

The product conveyor 9 comprises a drive 9A, which is controlled by a control unit 15.

The product conveyor 9 is assigned at least one light scanner 17, which detects the position of the baked items 3 on the product conveyor 9 and which is connected to the control unit 15.

Arranged at a distance above the product conveyor 9 is a feeding device 5 in the form of a conveying belt on which the distribution component 1 is intermittently conveyed along a feeding path ZR.

The feeding device 5 is provided with a drive 5A that is also controlled by the control unit 15.

During one discharge cycle, the distribution component 1 is conveyed on the feeding device 5 in feeding direction ZR, until it is released via a discharge edge 5AR of the feeding device 5 and is distributed over the baked item 3, wherein the preferred method is a cascading technique. During the discharge cycle, the distribution component 1 is conveyed continuously by the feeding device 5. The first movement of the guide chute 11 of a guiding device is preferably realized at a distance and approximately parallel to the product conveyor 9 and precisely positioned above the baked item 3, so that the first movement of the guiding device is synchronized with the movement of the baked item 3 for distributing the component thereon.

The distribution component 1 of the exemplary embodiment, which is conveyed on the feeding device 5, is grated cheese that can optionally be present at temperatures ranging from 0° C. to 20° C. or in the frozen state.

The mass of individual distribution component 1 pieces is advantageously determined with an optical method, described in the following, so that the detectable size of the individual pieces of the distribution component 1 is basically only restricted by the resolution of the cameras 23 used for the optical method. With a traditional linear resolution of a camera used with this method, for example having 1024 pixels for 250 mm detected length of the feeding device 5, a minimum detection area of up to 0.06 mm² is obtained for pieces of the distribution component 1.

The optical method for determining the mass of pieces of the distribution component 1 on the feeding device 5 uses two cameras 23 that are arranged above the feeding device 5. These cameras, which are also connected to the control unit 15, cover congruent detection areas 23E that are detected simultaneously.

With the aid of the cameras 23, images of the pieces in the distribution component 1 are generated from two directions, which are then sent to the control unit 15 and are used in the control unit 15 for determining a volume of the individual pieces based on the generated images and using an approximation, for example an ellipsoid. The control unit 15 accordingly is configured to compute the volume of the pieces in the distribution component, based on the data transmitted by at least one camera arranged above the conveying device. The volume of individual pieces of the distribution component 1, determined in this way, is then multiplied by the control unit 15 with the density of the distribution component 1, which provides the mass of pieces in the distribution component 1. Alternatively, the control unit 15 can be configured to compute an average volume per time unit, integrated over a predetermined time interval, in place of the volume of individual pieces in the distribution component.

Since the control unit 15 is connected to the drive 5A of the feeding device 5 and the cameras 23 are arranged at a fixed distance to the discharge edge 5AR of the feeding device 5, the control unit 15 can be provided with data that reflect the position of the individual pieces of the distribution component 1 on the feeding device 5, relative to the discharge edge 5A and their mass.

If a predetermined mass of the distribution components 1 is to be discharged during one discharge cycle, then the control unit 15 adds the mass of distribution component 1 pieces on the feeding device 5, starting from the discharge edge 5AR and counter to the feeding direction ZR, until the desired mass is reached. The resulting section (conveying length FL) is then conveyed by the feeding device 5 following a corresponding signal transmitted by the control unit 15 to the drive 5A of the feeding device 5, which causes the discharge of the predetermined mass of the distribution component 1.

The two cameras 23 and the control unit 15 therefore represent a mass-determination device 13 for determining the mass of individual pieces of the distribution component 1 on the feeding device 5 and for detecting their position on the feeding device 5, as well as optionally assigning a position to these pieces. The method disclosed in the German Patent 10 2006 035 266.1 or in the European Patent 07113029.8 can alternatively also be used as optical method for determining the mass of distribution component 1 pieces on the feeding device 5.

A guide chute 11 with an intake area 7 is arranged between the product conveyor 9 and the feeding device 5.

The guide chute 11 is cylindrical, wherein its diameter d corresponds to the diameter of the baked item 3 (the circular pizza crust). Alternatively, the diameter of the circular guide chute 11 can also be smaller than the diameter of the baked item 3.

The intake area 7 has a square intake opening 7ö at the upper end, wherein the side edges of the square intake opening 7ö, which extend perpendicular to the feeding direction ZR, have a length that is adapted to the width of the feeding device 5 in the same direction, so that the intake opening 7ö can accommodate the complete distribution component 1 discharged by the feeding device 5.

The square intake opening 7ö is conically tapered in downward direction and transitions to the circular cross-section of the guide chute 11, having an exit opening that is arranged at a distance and parallel to the product conveyor 9.

A horizontal guide 11F and a drive 11A that is connected to the control unit 15 are assigned to the guide chute 11, so that the guide chute 11 can traverse back and forth in horizontal direction along the guide 11F, parallel to the product-conveying direction PR, during a first movement and counter to the product-conveying direction during a second movement, as indicated with the horizontal double arrow parallel to the product conveying direction PR.

A vertical guide (not shown herein) with a corresponding drive that is also controlled by the control unit 15 is furthermore assigned to the guide chute 11, so that the guide chute 11 can also traverse back and forth in vertical direction, e.g. in the direction toward the product conveyor 9 at the start of the first movement and away from the product conveyor 9 at the end of the first movement.

The control unit 15 controls the two horizontal and vertical drives assigned to the guide chute 11 in such a way that at the start of the discharge cycle, the guide chute 11 is lowered from the starting position shown in FIG. 1 in the direction toward the baked item 3 in order to start the discharge of the distribution component 1 from the feeding device 5. The guide chute 11 is then moved in product conveying direction PR, in a positioned that coincides with the baked item 3, during a first movement. The first movement of the guide chute preferably continues until the predetermined mass of distribution components 1 has been discharged by the feeding device 5 and has been deposited onto the baked item 3, whereupon the guide chute 11 is lifted vertically off the baked item 3 into its end position and, in a second movement counter to the product-conveying direction PR, is moved back to its starting position, e.g. the starting position for the first movement.

The guide chute 11 and the intake area 7 thus ensure that the predetermined mass of the distribution component 1 is essentially only deposited on the horizontal section 3H of the baked item 3 and does not, for example, drop onto the product conveyor 9.

The control unit 15 controls the drives 5A and 9A for the feeding device 5 and/or the product conveyor 9, as well as the drives for the guide chute 11, in dependence on the signals from the light scanners 17 which indicate the position of the baked item 3 on the product conveyor 9.

For producing the areas 27 on the horizontal section 3H (see FIG. 2b), which are not covered by the distribution component 1, correspondingly shaped covering elements 25 can be arranged inside the guide chute 5 [sic]. For the exemplary embodiment, these can be cone-shaped covering elements 25 with a cross section parallel to the surface of the product conveyor 9 that corresponds to the desired area left uncovered. If the distribution component 1 hits a covering element 25 of this type, it slides downward along this element and, in the process, forms an area 27 on the horizontal section 3H that is not covered by the distribution component 1.

FIGS. 2a, 2b and 2c are views from above, shown at different production stages of the horizontal section 3H, onto which a topping is to be deposited:

FIG. 2a shows a view from above of the horizontal section 3H of the pizza crust 3, without a distribution component 1 deposited thereon, meaning a pizza crust 3 in the condition before it meets the guide chute 11, as seen counter to the product conveying direction PR. The pizza crusts 3 are preferably covered with a tomato sauce, which advantageously contains different types of herbs, wherein the tomato sauce is applied at a station along the production line that is upstream of the station for depositing the distribution component 1.

In FIG. 2b, the horizontal section 3H is shown with the distribution component 1 deposited thereon, wherein six circular areas 27 that are not covered by the distribution component 1 are formed with the aid of the covering elements 25.

FIG. 2c shows six salami slices 29 (piece component 29), which are respectively arranged in one of the non-covered areas 27 on the horizontal section 3H. These salami slices 29 were placed onto the non-covered areas 27 at a station (not shown herein) that follows in product-conveying direction the station for depositing the distribution component 1, wherein for the present example the slices were placed manually onto the non-covered areas 27. Alternatively, the salami slices 29 can also be deposited automatically onto the non-covered areas 27.

As a result of the above-described method steps, the salami slices 29 no longer rest on the grated cheese 1, meaning these ingredients are assigned to separate regions of the horizontal section 3H. The salami slices 29 consequently rest directly on the tomato sauce, causing them to adhere to the sauce and not to dry out on one side. If the pizza crust 3 is frozen at a following station along the production line to produce frozen pizza, then the salami slices 29 “adhere” to the tomato sauce and thus also the pizza crust, meaning they can no longer move around freely.

For the present example, cones were primarily be used for the covering elements 25. However, alternate elements can also be used, wherein these should advantageously be conical in shape to prevent the distribution component 1 from adhering to their surface. Additional elements that can be used, for example, are pyramids having a square or hexagonal outline. The elements are furthermore advantageously provided with an adhesion-prevention layer to prevent the distribution component 1 from adhering thereto.

According to an alternative embodiment to the one shown in FIG. 1, the guide chute 11 with the intake areas 7 and covering elements 25 is omitted. Instead, a flat template is moved along with the pizza crust 3, which is attached to the guide 11F. The template is provided with suitable openings for distributing the grated cheese as desired onto the pizza crust 3. The template preferably has a suitable three-dimensional profile to prevent the distribution component from adhering thereto, preferably in connection with a suitable adhesion-preventing coating.

According to a different alternative embodiment of the device according to FIG. 1, a template of this type is provided inside the guide chute 11 in place of the covering elements 25.

A different alternative embodiment provides that the distribution component 1 is not deposited with the aid of a cascading technique and that no means are used to prevent (covering elements 25, template) the covering of specified regions on the horizontal section 3H. Instead, the distribution component is deposited with a controlled feeding device onto specific regions of the horizontal section 3H.

One example of such a feeding device is a powdered sugar sprinkler, which is moved automatically across specified areas of the horizontal section 3H of a cake (baked item 3) and, in the process, deposits the powdered sugar exclusively in those areas, resulting in the non-covered areas 27. Chocolate or marzipan pieces can then be placed manually or automatically onto the non-covered areas 27. A sprinkler of this type can be used for depositing any type of distribution component 1, for example also for depositing cheese, especially hard cheese, onto a pizza crust.

A further example for such a feeding device is a cheese grater with therein inserted large piece of cheese, which is subsequently grated while cheese is simultaneously distributed onto the pizza crust.

It is advantageous if the guiding means, e.g. the covering elements 25 or the template, can also be cleaned during the operation to remove adhering pieces of the distribution component 1, for example through vibration with the aid of ultrasound, compressed air or by scraping the pieces off, for example with a rubber lip.

In FIG. 2, the non-covered areas 27 are displayed for illustration purposes as precise circular surfaces. However, such precisely delineated, non-covered areas 27 are not actually formed during the operation of the system according to FIG. 1 because of the size of the distribution component pieces and the technique used for depositing these (“cascading technique”). The dimensions of these non-covered areas 27 can be selected large enough, so that the piece component can be arranged easily therein, wherein the dimensions of the non-covered areas 27 should advantageously be selected to allow the piece component 29 to rests at least in some sections on the distribution component 1, for example along a peripheral edge.

### LIST OF REFERENCE NUMBERS

1 distribution component
3 baked good (e.g. pizza crust)
3H horizontal section of the baked good
5 feeding device
5A drive for the feeding device
5AR discharge edge of the feeding device
7 intake area
7ö intake opening
9 product conveyor, endless conveyor
9A drive for the product conveyor
11 guide chute
11F guidance in the guide chute (horizontal guidance)
11A drive for the guide chute
13 mass determination device
15 control
17 light scanner
23 camera
23E detection range of the camera
25 covering element
27 non-covered area
29 piece component
d guide chute 11 diameter
FL conveying belt section with thereon arranged material to be discharged
PR product conveying direction
ZR feeding direction

1. A continuous method for decorating a horizontal section of a flat baked item or depositing a topping thereon, along a production line, said method involving the following steps:
a) placing the flat baked item onto a continuously driven endless conveyor at a station along the production line;
b) continuously depositing at least one distribution component onto a horizontal section of the baked good; and
c) depositing at least one piece of a piece component onto the horizontal section,
characterized by
d) forming at least one non-covered area on the horizontal section, which is kept free of a distribution component, during the continuous depositing of the distribution component in step b), and
e) arranging at least one piece of the piece component on the at least one non-covered area created during the step d).

2. The method according to claim 1, wherein the distribution component is conveyed continuously or intermittently into a guide chute of a guiding device, which is moved with a first movement parallel to the endless conveyor in the direction of and with the speed of the endless conveyor and is moved with a second movement back to the starting position for the first movement.

3. The method according to claim 1, wherein the guiding device comprises at least one covering element with a conical cross section, for which the cross section is arranged parallel to the endless conveyor and corresponds to the non-covered area.

4. The method according to claim 1, wherein the mass of the distribution component is metered out.

5. The method according to claim 1, wherein the endless conveyor is driven intermittently.

6. The method according to claim 1, wherein the horizontal section includes essentially the complete, flat upper surface of the baked item.

7. The method according to claim 1, wherein the distribution component is deposited with the aid of a cascading technique and that the piece component is deposited purposely, either manually or with the aid of a dispensing device, on the at least one non-covered area.

8. The method according to claim 1, wherein one piece of a piece component is placed onto a non-covered area and that the shape and size of the non-covered area coincide with the shape and size of the piece component piece to be deposited thereon.

9. The method according to claim 1, wherein several pieces of the piece component are arranged on a non-covered area.

10. The method according to claim 9, wherein the same type of piece component is arranged in each of the non-covered areas.

11. The method according to claim 9, wherein respectively different piece components are arranged in at least two non-covered areas.

12. The method according to claim 1, wherein prior to the step b), a liquid component is applied to the horizontal section.

13. A device for realizing a method according to claim 1 for decorating a horizontal section of a flat baked item or depositing a topping thereon, wherein the device comprises an endless conveyor for transporting the baked items, at least one station for depositing at least one distribution component, and at least one station for depositing at least one piece component, wherein the at least one station for depositing the distribution component is provided with a guiding device, which creates at least one non-covered area on the horizontal section of the baked item during the depositing of the distribution component, and that the at least one station for depositing the at least one piece component is provided with a device for the targeted depositing of the piece component onto the at least one non-covered area.

14. The device according to claim 13, wherein the at least one station for depositing the at least one distribution component comprises a guiding device having a maximum cross-sectional area that spans the same area as the outer circumference of the baked item, and that the guiding device can be moved during a first movement with a positioning device across a section of the endless conveyor while positioned parallel and at a distance thereto, as well as moving with the same speed as the endless conveyor.

15. The device according to claim 13, wherein a covering element or a template is arranged inside the guide chute of the guiding device.

16. The device according to claim 13, wherein the guiding device comprises a feeding device for the distribution component.

17. The device according to claim 13, wherein the endless conveyor is a circulating conveying belt.

18. The device according to claim 13, wherein the at least one station for depositing at least one distribution component is provided with a continuously or intermittently driven distributing device for moving the distribution component with the aid of a cascading technique into an intake opening of the guiding device.

19. The device according to claim 13, wherein the guiding device, in a second movement that alternates with the first movement, can be moved back to the starting position for the first movement.

20. The device according to claim 19, wherein following the passage for the first movement, the guiding device can be moved at a greater distance to the endless conveyor and that the device is positioned for the second movement at a greater distance and for the first movement at a shorter distance to the endless conveyor.
